(19) United States
(12) Patent Application Publication
(10) Pub. No.: US 2023/0334915 A1
(43) Pub. Date: Oct. 19, 2023

(54) PROGRAM TO COLLECT VEHICLE LOG, IN-VEHICLE DEVICE, VEHICLE LOG COLLECTION SYSTEM, AND VEHICLE LOG COLLECTION METHOD

(71) Applicant: Sumitomo Electric Industries, Ltd., Osaka-shi, Osaka (JP)

(72) Inventor: Junji YANO, Osaka-shi, Osaka (JP)

(73) Assignee: Sumitomo Electric Industries, Ltd., Osaka-shi, Osaka (JP)

(21) Appl. No.: 18/028,835

(22) PCT Filed: Sep. 24, 2021
(86) PCT No.: PCT/JP2021/034942

§ 371 Date: Mar. 28, 2023

(30) Foreign Application Priority Data
Oct. 6, 2020 (JP) 2020-168793

(51) Int. Cl. G07C 5/00; G07C 5/08

(52) U.S. Cl. CPC G07C 5/008; G07C 5/085

(57) ABSTRACT

A non-transitory computer-readable recording medium storing a vehicle log collection program causes a computer serving as an in-vehicle device to function as a reception unit configured to receive designation of identification information identifying first application software for use in a vehicle having a first storage unit and a second storage unit; an acquisition unit configured to acquire correspondence information indicating that the first application software is associated with at least one of second application software that is for use in the vehicle and different from the first application software or a service for use in the vehicle; and a transmission processing unit configured to acquire first log information that is stored in the first storage unit and is on the first application software corresponding to the identification information from the first storage unit, and transmit the first log information to a device installed outside the vehicle.

### TECHNICAL FIELD

The present disclosure relates to a program to collect vehicle log, an in-vehicle device, a vehicle log collection system, and a vehicle log collection method.

This application claims priority based on Japanese Patent Application No. 2020-168793 filed on Oct. 6, 2020, and the entire contents of the Japanese Patent Application are incorporated herein by reference.

### BACKGROUND ART

For example, Japanese Unexamined Patent Application Publication No. 2018-170754 (PTL 1) discloses the following technique as abnormality processing in response to an abnormality occurred in a vehicle. That is, an abnormality detection ECU determines an abnormality by using a rule table with respect to the three values of a current value “reverse” of a gear control information which is data to be monitored, a past value “drive” of the gear control information which is data to be monitored, and a current value “advance” of a speed control information which is data to be compared. Subsequently, since the abnormality detection ECU has determined that there is an abnormality, the abnormality detection ECU performs transmission prevention processing of a message including the gear control information which is the data to be monitored as vehicle protection processing. In addition, as the vehicle protection processing, the abnormality detection ECU further instructs an external communication device to perform an abnormality notification transmission processing of transmitting information indicating the abnormality to a server.

### CITATION LIST

### Patent Literature

PTL 1: Japanese Unexamined Patent Application Publication No. 2018-170754

### SUMMARY OF INVENTION

A program to collect vehicle log according to the present disclosure is a program to collect vehicle log that causes a computer serving as an in-vehicle device to function as a reception unit configured to receive designation of identification information identifying first application software for use in a vehicle having a first storage unit and a second storage unit; an acquisition unit configured to acquire correspondence information indicating that the first application software is associated with at least one of second application software that is for use in the vehicle and different from the first application software or a service for use in the vehicle; and a transmission processing unit configured to acquire first log information that is stored in the first storage unit and is on the first application software corresponding to the identification information from the first storage unit, acquire second log information that is stored in the second storage unit and is on at least one of the second application software or the service that is associated with the first application software from the second storage unit, and transmit the first log information and the second log information to a device installed outside the vehicle.

An in-vehicle device according to the present disclosure includes a reception unit configured to receive designation of identification information identifying first application software for use in a vehicle having a first storage unit and a second storage unit; an acquisition unit configured to acquire correspondence information indicating that the first application software is associated with at least one of second application software that is for use in the vehicle and different from the first application software or a service for use in the vehicle; and a transmission processing unit configured to acquire first log information that is stored in the first storage unit of the vehicle and is on the first application software corresponding to the identification information from the first storage unit, acquire second log information that is stored in the second storage unit and is on at least one of the second application software or the service that is associated with the first application software from the second storage unit, and transmit the first log information and the second log information to a device installed outside the vehicle.

A vehicle log collection system according to the present disclosure includes an in-vehicle device to be mounted in a vehicle having a first storage unit and a second storage unit, and a management device to be provided outside the vehicle and capable of communicating with the in-vehicle device. The in-vehicle device includes a reception unit configured to receive designation of identification information identifying first application software for use in the vehicle; an acquisition unit configured to acquire correspondence information indicating that the first application software is associated with at least one of the second application software that is for use in the vehicle and different from the first application software or a service for use in the vehicle; and a transmission processing unit configured to acquire first log information that is stored in the first storage unit of the vehicle and is on the first application software corresponding to the identification information from the first storage unit, acquire second log information that is stored in the second storage unit and is on at least one of the second application software or the service that is associated with the first application software from the second storage unit, and transmit the first log information and the second log information to the management device.

A vehicle log collection method according to the present disclosure is a vehicle log collection method for an in-vehicle device to be mounted in a vehicle having a first storage unit and a second storage unit. The method includes receiving designation of identification information identifying first application software for use in the vehicle; acquiring correspondence information indicating that the first application software is associated with at least one of second application software that is for use in the vehicle and different from the first application software or a service for use in the vehicle; and acquiring first log information that is stored in the first storage unit of the vehicle and is on the first application software corresponding to the identification information from the first storage unit, acquiring second log information that is stored in the second storage unit and is on at least one of the second application software or the service that is associated with the first application software from the second storage unit, and transmitting the first log information and the second log information to a device installed outside the vehicle.

A program to collect vehicle log according to the present disclosure is a program that causes a computer serving as an in-vehicle device to function as a reception unit configured to receive designation of identification information identifying application software for use in a vehicle, and designation of third reference information indicating a storage location of log information on the application software by a relative path with respect to a storage location of the application software; an acquisition unit configured to acquire fourth reference information indicating the storage location of the application software corresponding to the identification information; and a transmission processing unit configured to specify, based on the third reference information and the fourth reference information, the storage location of the log information on the application software, acquire the log information from the specified storage location, and transmit the acquired log information to a device installed outside the vehicle.

A vehicle log collection method according to the present disclosure is a vehicle log collection method for an in-vehicle device to be mounted in a vehicle. The method includes receiving designation of identification information identifying application for use in the vehicle, and designation of third reference information indicating a storage location of log information on the application software by a relative path with respect to a storage location of the application software; acquiring fourth reference information indicating the storage location of the application software corresponding to the identification information; specifying, based on the third reference information and the fourth reference information, the storage location of the log information on the application software; acquiring the log information from the specified storage location; and transmitting the acquired log information to a device installed outside the vehicle.

One aspect of the present disclosure can be realized as a semiconductor integrated circuit that realizes part or all of an in-vehicle device.

### BRIEF DESCRIPTION OF DRAWINGS

FIG. 1 is a diagram illustrating a configuration of a vehicle management system according to a first embodiment of the present disclosure.

FIG. 2 is a diagram illustrating a configuration of an in-vehicle network according to the first embodiment of the present disclosure.

FIG. 3 is a diagram illustrating log management of application software in the vehicle management system according to the first embodiment of the present disclosure.

FIG. 4 is a diagram illustrating a configuration of an in-vehicle device according to the first embodiment of the present disclosure.

FIG. 5 is a diagram illustrating an example of a correspondence relationship between the application software and other application software or the like according to the first embodiment of the present disclosure.

FIG. 6 is a diagram illustrating an example of correspondence information according to the first embodiment of the present disclosure.

FIG. 7 is a diagram illustrating a method of acquiring the correspondence information by an application management unit according to the first embodiment of the present disclosure.

FIG. 8 is a diagram illustrating an example of a relationship between application software to be managed, and other application software and a service in the vehicle management system according to the first embodiment of the present disclosure.

FIG. 9 is a sequence illustrating a vehicle management method in the vehicle management system according to the first embodiment of the present disclosure.

FIG. 10 is a diagram illustrating a configuration of an in-vehicle device according to a second embodiment of the present disclosure.

FIG. 11 is a diagram illustrating an example of correspondence information used for abnormality detection by a detection unit in the in-vehicle device according to the second embodiment of the present disclosure.

FIG. 12 is a diagram illustrating a notification method of a detection result by the detection unit according to the second embodiment of the present disclosure.

FIG. 13 is a diagram illustrating a configuration of a vehicle monitoring system according to a third embodiment of the present disclosure.

FIG. 14 is a diagram illustrating an example of a log collection method for application software to be managed in a vehicle monitoring system according to a fourth embodiment of the present disclosure.

### DETAILED DESCRIPTION

### Problems to be Solved by the Present Disclosure

With the spread of connected cars, vehicles increasingly connect to an external server via a network, as in the case of PTL 1. This increases the possibility that the vehicles are attacked from the outside via the network. Therefore, it is necessary for the server to detect incidents that have occurred or are likely to occur in the future at an early stage by transmitting logs from the vehicles to the server as needed. However, when each application software operating in the vehicle directly transmits a log to the server, the server needs to monitor each communication in order to ensure security. In this case, the server monitors the communication as many times as the number of pieces of application software, which increases a load on the server for monitoring. In addition, for effective analysis by the server, it is necessary for the server to acquire a log of other application software having a correspondence relationship with the application software for vehicle to be managed. However, it is difficult for the server to grasp the correspondence relationship between the application software and the other application software because the correspondence relationship between each application software may be changed when each application software is updated, and each application software may have a different distributor creator, and the like. For this reason, an administrator of the server needs to refer to a design document of each application software or conduct an interview survey from the creator of each application software to grasp the correspondence relationship between each application software, and the server cannot dynamically grasp the correspondence relationship between each application software.

The present disclosure has been made to address the above-described issue, and an object of the present disclosure is to provide a program to collect vehicle log, an in-vehicle device, a vehicle log collection system, and a vehicle log collection method that enable efficient collection of log information of application software mounted in a vehicle.

### Advantageous Effects of Present Disclosure

According to the present disclosure, it is possible to efficiently collect log information of application software mounted in a vehicle. [Description of Embodiments of the Present Disclosure]

First, the contents of embodiments of the present disclosure will be listed and described.

(1) A program to collect vehicle log according to an embodiment of the present disclosure is a program to collect vehicle log that causes a computer serving as an in-vehicle device to function as a reception unit configured to receive designation of identification information identifying first application software for use in a vehicle having a first storage unit and a second storage unit; an acquisition unit configured to acquire correspondence information indicating that the first application software is associated with at least one of second application software that is for use in the vehicle and different from the first application software or a service for use in the vehicle; and a transmission processing unit configured to acquire first log information that is stored in the first storage unit and is on the first application software corresponding to the identification information from the first storage unit, acquire second log information that is stored in the second storage unit and is on at least one of the second application software or the service that is associated with the first application software from the second storage unit, and transmit the first log information and the second log information to a device installed outside the vehicle.

This configuration allows the in-vehicle device to grasp at least one of the other application software or the service having the correspondence relationship with the application software to be managed. Therefore, an administrator can easily acquire related log information by designating an application software to the in-vehicle device, for example, without manually investigating the other application software or the like associated with the application software to be managed. Therefore, it is possible to efficiently manage the state of the vehicle in which the application software is installed.

When the log information of the application software to be managed is transmitted to the other device, the transmission processing unit can mediate communication between the application software and the other device. As a result, the administrator can ensure security by monitoring communication between the transmission processing unit and the other device, eliminating the need to monitor individual communication between the application software and the other device, and reducing a cost for monitoring.

(2) The vehicle may have a third storage unit. The acquisition unit may be configured to acquire first outline log information that includes first reference information indicating a storage location of the first log information, and second outline log information that includes second reference information indicating a storage location of the second log information from the third storage unit. The transmission processing unit may be configured to acquire the first log information from the first storage unit by using the first reference information, and acquire the second log information from the second storage unit by using the second reference information.

This configuration allows the in-vehicle device to easily acquire the log information stored in each area of a memory or each memory in an in-vehicle network, for example, by using the reference information.

(3) The first outline log information may be information created, by the first application software, by omitting or converting at least part of the first log information. The second outline log information may be information created, by the second application software, by omitting or converting at least part of the second log information.

With such a configuration, since the application software itself creates the outline log information at a timing when, for example, an abnormality has occurred or may occur in the application software, it is possible to efficiently create the outline log information according to an event in the vehicle.

(4) The program to collect vehicle log may further cause the computer to function as a detection unit configured to detect an abnormality of the first application software and an abnormality of the second application software. The first outline log information may be created in response to the abnormality of the first application software being detected by the detection unit. The second outline log information may be created in response to the abnormality of the second application software being detected by the detection unit.

This configuration enables the detection unit to detect an abnormality, for example, even when the abnormality that cannot be detected by the application software itself occurs in the application software. Therefore, it is possible to more accurately manage the state of the vehicle in which the application software is installed.

(5) The first outline log information may include an error log of the first application software. The second outline log information may include an error log of the second application software.

This configuration allows the administrator to easily analyze the abnormality of the application.

(6) The correspondence information may indicate that the first application software corresponding to the identification information is associated with the second application software and the service.

This configuration allows the in-vehicle device to transmit the log information of all other applications and all services associated with the application to be managed to the other device. Therefore, the administrator can comprehensively analyze the abnormality of the application.

(7) An in-vehicle device according to an embodiment of the present disclosure includes a reception unit configured to receive designation of identification information identifying first application software for use in a vehicle having a first storage unit and a second storage unit; an acquisition unit configured to acquire correspondence information indicating that the first application software is associated with at least one of second application software that is for use in the vehicle and different from the first application software or a service for use in the vehicle; and a transmission processing unit configured to acquire first log information that is stored in the first storage unit of the vehicle and is on the first application software corresponding to the identification information from the first storage unit, acquire second log information that is stored in the second storage unit and is on at least one of the second application software or the service that is associated with the first application software from the second storage unit, and transmit the first log information and the second log information to a device installed outside the vehicle.

This configuration allows the in-vehicle device to grasp at least one of the other application software or the service having the correspondence relationship with the application software to be managed. Hence, the administrator can easily acquire related log information by designating the application to the in-vehicle device without manually investigating the other application software or the like associated with the application software to be managed, for example. Therefore, it is possible to efficiently manage the state of the vehicle in which the application software is installed.

When the log information of the application to be managed is transmitted to the other device, the transmission processing unit can mediate communication between the application and the other device. As a result, the administrator can ensure security by monitoring communication between the transmission processing unit and the other device, eliminating the need to monitor individual communication between the application and the other device, and reducing a cost for monitoring.

(8) A vehicle log collection system according to an embodiment of the present disclosure includes an in-vehicle device to be mounted in a vehicle having a first storage unit and a second storage unit, and a management device to be provided outside the vehicle and capable of communicating with the in-vehicle device. The in-vehicle device includes a reception unit configured to receive designation of identification information identifying first application software for use in the vehicle; an acquisition unit configured to acquire correspondence information indicating that the first application software is associated with at least one of the second application software that is for use in the vehicle and different from the first application software or a service for use in the vehicle; and a transmission processing unit configured to acquire first log information that is stored in the first storage unit of the vehicle and is on the first application software corresponding to the identification information from the first storage unit, acquire second log information that is stored in the second storage unit and is on at least one of the second application software or the service that is associated with the first application software from the second storage unit, and transmit the first log information and the second log information to the management device.

This configuration allows the in-vehicle device to grasp at least one of the other application software or the service having the correspondence relationship with the application software to be managed. Therefore, the administrator can easily acquire related log information by designating the application to the in-vehicle device without manually investigating the other application software or the like associated with the application software to be managed, for example. Therefore, it is possible to efficiently manage the state of the vehicle in which the application software is installed.

Further, when the log information of the application to be managed is transmitted to the management device, the transmission processing unit may mediate communication between the application and the management device. As a result, the administrator can ensure security by monitoring communication between the transmission processing unit and the management device, eliminating the need to monitor individual communication between the application and the management device, and reducing a cost for monitoring.

(9) A vehicle log collection method according to the present disclosure is a vehicle log collection method for an in-vehicle device to be mounted in a vehicle having a first storage unit and a second storage unit. The method includes receiving designation of identification information identifying first application software for use in the vehicle; acquiring correspondence information indicating that the first application software is associated with at least one of second application software that is for use in the vehicle and different from the first application software or a service for use in the vehicle; and acquiring first log information that is stored in the first storage unit of the vehicle and is on the first application software corresponding to the identification information from the first storage unit, acquiring second log information that is stored in the second storage unit and is on at least one of the second application software or the service that is associated with the first application software from the second storage unit, and transmitting the first log information and the second log information to a device installed outside the vehicle.

This configuration allows the in-vehicle device to grasp at least one of the other application software or the service having the correspondence relationship with the application software to be managed. Therefore, the administrator can easily acquire related log information by designating the application to the in-vehicle device without manually investigating the other application software or the like associated with the application software to be managed, for example. Therefore, it is possible to efficiently manage the state of the vehicle in which the application software is installed.

Further, when the log information of the application to be managed is transmitted to the other device, the in-vehicle device can mediate communication between the application and the other device. As a result, the administrator can ensure security by monitoring communication between the in-vehicle device and the other device, eliminating the need to monitor individual communication between the application and the other device, and reducing a cost for monitoring.

(10) A program to collect vehicle log according to an embodiment of the present disclosure is a program to collect vehicle log that causes a computer serving as an in-vehicle device to function as a reception unit configured to receive designation of identification information identifying application software for use in a vehicle, and designation of third reference information indicating a storage location of log information on the application software by a relative path with respect to a storage location of the application software; an acquisition unit configured to acquire fourth reference information indicating the storage location of the application software corresponding to the identification information; and a transmission processing unit configured to specify, based on the third reference information and the fourth reference information, the storage location of the log information on the application software, acquire the log information from the specified storage location, and transmit the acquired log information to a device installed outside the vehicle.

This configuration allows the transmission processing unit to mediate communication between the application and the other device when detailed log information of the application to be managed is transmitted to the other device. As a result, the administrator can ensure security by monitoring communication between the transmission processing unit and the other device, eliminating the need to monitor individual communication between the application and the other device, and reducing a cost for monitoring. Therefore, it is possible to efficiently manage the state of the vehicle in which the application software is installed.

(11) A vehicle log collection method according to an embodiment of the present disclosure is a vehicle log collection method for an in-vehicle device to be mounted in a vehicle. The method includes receiving designation of identification information identifying application for use in the vehicle, and designation of third reference information indicating a storage location of log information on the application software by a relative path with respect to a storage location of the application software; acquiring fourth reference information indicating the storage location of the application software corresponding to the identification information; specifying, based on the third reference information and the fourth reference information, the storage location of the log information on the application software; acquiring the log information from the specified storage location; and transmitting the acquired log information to a device installed outside the vehicle.

This configuration allows the transmission processing unit to mediate communication between the application and the other device when detailed log information of the application to be managed is transmitted to the other device. As a result, the administrator can ensure security by monitoring the communication between transmission processing unit and the other device, eliminating the need to monitor the communication between the application and the other device, and reducing a cost for monitoring. Therefore, it is possible to efficiently manage the state of the vehicle in which the application software is installed.

Hereinafter, embodiments of the present disclosure will be described with reference to the drawings. Note that the same or corresponding parts in the drawings are denoted by the same reference numerals, and description thereof will not be repeated. Further, at least some of the embodiments described below may be arbitrarily combined.

### First Embodiment

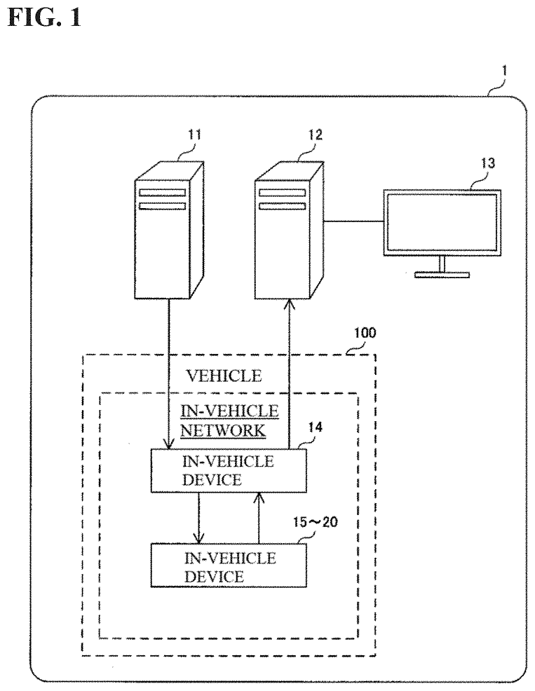

FIG. 1 is a diagram illustrating a configuration of a vehicle management system according to a first embodiment of the present disclosure. FIG. 1 illustrates management contents for application software in an in-vehicle network as an example. Note that the term of the application software may be abbreviated to be referred to as an application or an application soft.

Referring to FIG. 1, a vehicle management system 1 includes management devices 11 and 12, a display device 13, and in-vehicle devices 14 to 20.

Management device 11 is, for example, an Over the Air (OTA) server, and updates various kinds of software used in the in-vehicle network.

Management device 12 is, for example, a Security Operation Center (SOC) server, and monitors the in-vehicle network, and detects and analyzes a cyber-attack, for example. Management device 12 is, for example, a cloud server.

Display device 13 is, for example, a liquid crystal display. Display device 13 is connected to management device 12 and displays information received from management device 12.

In-vehicle device 14 is mounted in a vehicle 100. In-vehicle device 14 is, for example, a central ECU (Electronic Control Unit), and constitutes an in-vehicle network with in-vehicle devices 15 to 20 mounted in vehicle 100. The connection relationship between the in-vehicle devices in the in-vehicle network is fixed, for example.

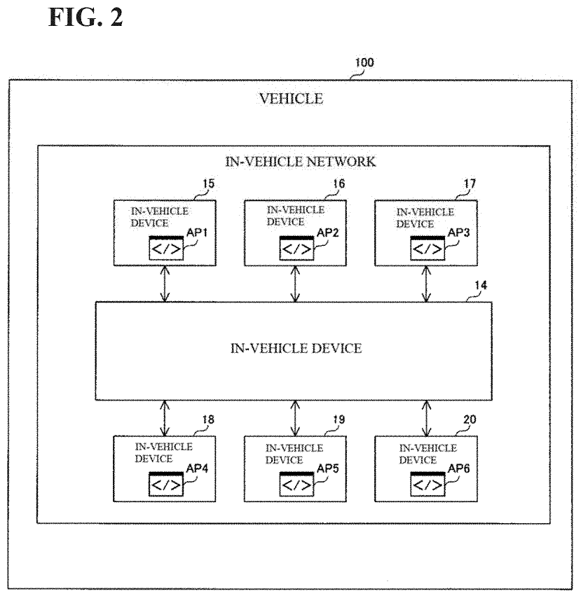

FIG. 2 is a diagram illustrating a configuration of the in-vehicle network according to the first embodiment of the present disclosure. Referring to FIG. 2, a plurality of in-vehicle devices 15 to 20 in addition to in-vehicle device 14 is mounted in vehicle 100.

In-vehicle devices 15 to 20 are, for example, an automatic driving ECU (Electronic Control Unit), an engine ECU, a sensor, a navigation device, a human machine interface, a camera, and the like. In-vehicle devices 15 to 20 communicate with management devices 11 and 12 via, for example, a TCU (Telematics Control Unit) that is an in-vehicle device (not illustrated), a wireless base station, and the like.

In the in-vehicle network, in-vehicle device 14 is connected to in-vehicle devices 15 to 20 with an Ethernet (registered trademark) cable. In-vehicle device 14 can communicate with in-vehicle devices 15 to 20 connected to in-vehicle device 14. In-vehicle device 14 can relay data between in-vehicle devices 15 to 20 connected to in-vehicle device 14.

In-vehicle device 14 performs relay processing of an Ethernet frame according to the communication standard of the Ethernet. Specifically, in-vehicle device 14 relays, for example, the Ethernet frame exchanged between in-vehicle devices 15 to 20. An IP packet is stored in the Ethernet frame.

Note that the in-vehicle network is not limited to a configuration in which the Ethernet frame is relayed in accordance with the communication standard of the Ethernet, and may be a configuration in which data is relayed in accordance with a communication standard such as Controller Area Network (CAN, registered trademark), FlexRay (registered trademark), Media Oriented Systems Transport (MOST, registered trademark), or Local Interconnect Network (LIN).

As an example, application software AP1 is installed in in-vehicle device 15, and application software AP2 to AP6 are installed in in-vehicle devices 16 to 20, respectively.

Each of application software AP1 to AP6 performs a predetermined operation in the in-vehicle device in which it is installed, and creates a log. The log of each application software AP1 to AP6 is managed by in-vehicle device 14.

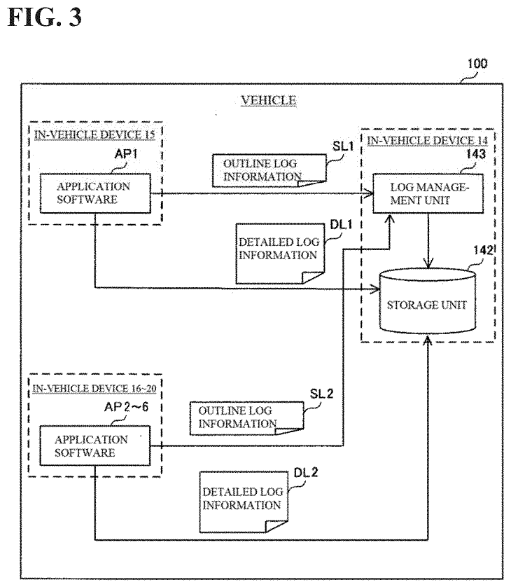

FIG. 3 is a diagram illustrating log management of application software in the vehicle management system according to the first embodiment of the present disclosure.

Referring to FIG. 3, application software AP1 in in-vehicle device 15 creates log information (hereinafter also referred to as detailed log information DL1) indicating a history of a use state of the application software, a history of data communication with other in-vehicle devices, and the like. An in-vehicle communication unit (not shown) in in-vehicle device 15 transmits detailed log information DL1 to in-vehicle device 14 via the in-vehicle network. As will be described later, detailed log information DL1 is stored in a storage unit 142 of in-vehicle device 14.

In addition, application software AP1 periodically creates outline log information SL1 simplified by omitting part of the content of detailed log information DL1 or converting part or all of the content. Outline log information SL1 includes reference information (first reference information) that can identify detailed log information DL1. The reference information is, for example, information indicating a storage location of detailed log information DL1, and is, for example, a file path. The in-vehicle communication unit (not shown) in in-vehicle device 15 periodically transmits outline log information SL1 to in-vehicle device 14 via the in-vehicle network. As will be described later, outline log information SL1 is stored in storage unit 142 via a log management unit 143 in in-vehicle device 14.

Further, application software AP1 has an error detection function of detecting an operation abnormality of application software AP1. Specifically, the program code of application software AP1 includes, for example, an error processing code for monitoring an execution status of application software AP1. When application software AP1 reaches the error processing code during execution of the processing, application software AP1 detects an error of application software AP1. When an error is detected, application software AP1 includes an error log in detailed log information DL1 and outline log information SL1 to transmit them to in-vehicle device 14.

Although the log management of application software AP1 has been described with reference to FIG. 3, the same applies to the other application software AP2 to AP6. That is, each of application software AP2 to AP6 creates log information (hereinafter, also referred to as detailed log information DL2) indicating a history of a use state of a service, a history of data communication with other in-vehicle devices, and the like of each of application software AP2 to AP6. The in-vehicle communication unit in each of in-vehicle devices 16 to 20 to which application software AP2 to AP6 are installed transmits detailed log information DL2 to in-vehicle device 14 via the in-vehicle network.

In addition, each of application software AP2 to AP6 creates outline log information SL2 simplified by omitting part of the content of detailed log information DL2 of each of application software AP2 to AP6 or converting part or all of the content of detailed log information DL2. Outline log information SL2 includes reference information (second reference information) that can identify detailed log information DL2, i.e., that indicates a storage location of detailed log information DL2. The in-vehicle communication unit in each of in-vehicle devices 16 to 20 periodically transmits outline log information SL2 of application software AP2 to AP6 to in-vehicle device 14 via the in-vehicle network.

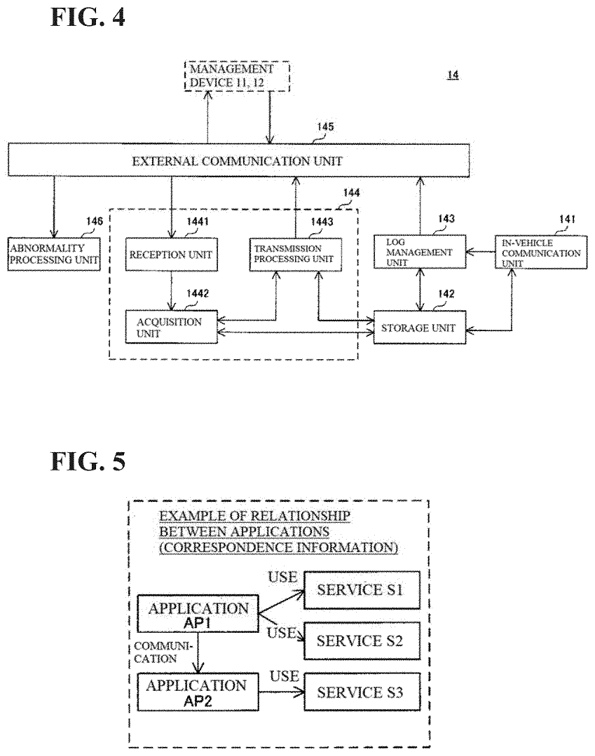

FIG. 4 is a diagram illustrating a configuration of an in-vehicle device according to the first embodiment of the present disclosure.

Referring to FIG. 4, in-vehicle device 14 includes an in-vehicle communication unit 141, storage unit 142, log management unit 143, an application management unit 144, an external communication unit 145, and an abnormality processing unit 146. Application management unit 144 includes a reception unit 1441, an acquisition unit 1442, and a transmission processing unit 1443.

In-vehicle communication unit 141 and external communication unit 145 are realized by, for example, a communication circuit such as an integrated circuit (IC) for communication. Storage unit 142 is, for example, a nonvolatile memory. Log management unit 143, application management unit 144, and abnormality processing unit 146 are realized by a processor such as a central processing unit (CPU) or a digital signal processing (DSP), for example.

In-vehicle communication unit 141 stores detailed log information DL1 and DL2 of each of application software AP1 to AP6 received via the in-vehicle network in storage unit 142. Further, in-vehicle communication unit 141 outputs outline log information SL1 and SL2 received via the in-vehicle network to log management unit 143.

Log management unit 143 stores outline log information SL1 and SL2 received from in-vehicle communication unit 141 in storage unit 142, and also transmits outline log information SL1 and SL2 to management device 12 via external communication unit 145. Log management unit 143 stores, for example, the time at which outline log information SL1 and SL2 were created, the IDs of the application software that created outline log information SL1 and SL2, the file paths to detailed log information DL1 and DL2, the content of processing or an event and its result of error detection in storage unit 142. The processing or event is, for example, communication processing with other application software, service search processing, an event of sensor data reception, or the like.

Management device 12 analyzes outline log information SL1 and SL2 received from in-vehicle device 14. Management device 12 visualizes a management state of vehicle 100 by performing processing of displaying the analysis result on the screen of display device 13, for example. Specifically, for example, when management device 12 determines that the operation of application software AP1 in in-vehicle device 15 is normal based on the analysis result of outline log information SL1, management device 12 displays a graph indicating the monitoring state and a message indicating that the operation is normal on the screen of display device 13.

For example, when the error log is included in received outline log information SL1, management device 12 designates the application software that has created outline log information SL1, and requests in-vehicle device 14 for detailed log information DL1 of the application software. In this example, management device 12 designates application software AP1. More specifically, management device 12 transmits a detailed log request including identification information of application software AP1 to external communication unit 145 in in-vehicle device 14. The identification information is, for example, an application identification (ID).

External communication unit 145 outputs the detailed log request received from management device 12 to application management unit 144.

In application management unit 144, reception unit 1441 receives designation of identification information identifying application software for vehicle 100. More specifically, reception unit 1441 receives the detailed log request including the identification information of application software AP1 from management device 12 via external communication unit 145. Reception unit 1441 outputs the identification information included in the received detailed log request to acquisition unit 1442.

Acquisition unit 1442 acquires correspondence information indicating that application software AP1 is associated with at least one of other application software for vehicle 100 or a service for vehicle 100. More specifically, acquisition unit 1442 receives the identification information of application software AP1 from reception unit 1441 and acquires correspondence information that can identify at least one of the other application software or the service used by application software AP1 from storage unit 142. For example, in the correspondence information, the ID of application software AP1 is associated with at least one of the ID of the other application software or the service. Acquisition unit 1442 outputs the acquired correspondence information to transmission processing unit 1443.

FIG. 5 is a diagram illustrating an example of a correspondence relationship between the application software and the other application software according to the first embodiment of the present disclosure.

Referring to FIG. 5, application software AP1 uses, for example, services S1 and S2 in vehicle 100. For example, application software AP1 is application software that uses an image captured by a camera, and services S1 and S2 are services that provide the captured image of the camera and the measurement result of the sensor, respectively. Therefore, application software AP1 has a correspondence relationship with services S1 and S2. Further, application software AP1 communicates with application software AP2 via the in-vehicle network, for example. Application software AP2 uses a service S3 in vehicle 100. Therefore, application software AP1 also has a correspondence relationship with application software AP2 and service S3.

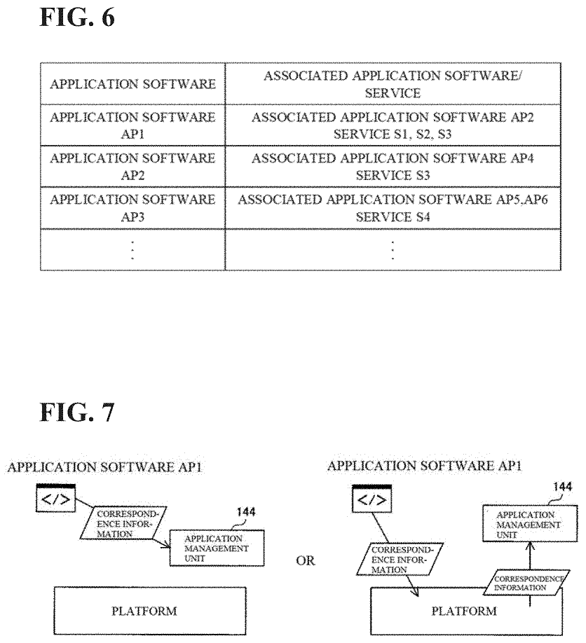

FIG. 6 is a diagram illustrating an example of correspondence information according to the first embodiment of the present disclosure.

Referring to FIG. 6, the correspondence information describes the application software to be managed and the ID of at least one of the other application software or the service used by the application software in vehicle 100.

For example, the correspondence information describes the IDs of application software AP2 and services S1, S2, and S3 for application software AP1. Similarly, for application software AP2 to AP6, the ID of at least one of other application software or a service having a correspondence relationship with application software AP2 to AP6 is described.

At least one of application software AP2 to AP6 may be application software that is executed alone without using other application software and a service. In short, at least one application software that can be managed in vehicle management system 1 may have a correspondence relationship with at least one of the other application software or the service.

FIG. 7 is a diagram illustrating a method of acquiring correspondence information by application management unit 144 according to the first embodiment of the present disclosure.

Referring to FIG. 7, correspondence information is deployed in vehicle management system 1 before application software AP1 to be managed is installed in vehicle 100.

The deployment destination may be application management unit 144, or may be a platform or middleware that executes application software AP1. That is, the correspondence information is directly registered in storage unit 142, or application management unit 144 acquires the correspondence information from the platform or the like and stores the correspondence information in storage unit 142.

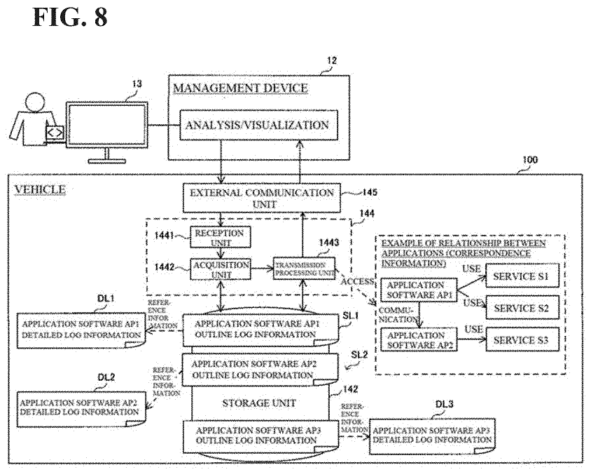

FIG. 8 is a diagram illustrating an example of a relationship between an application software to be managed, and other application software and services in the vehicle management system according to the first embodiment of the present disclosure.

Referring to FIG. 8, acquisition unit 1442 in application management unit 144 acquires outline log information SL1 and SL2 including reference information capable of identifying detailed log information DL1 of application software AP1 and detailed log information DL2 of at least one of the other application software or the service having a correspondence relationship with application software AP1.

More specifically, acquisition unit 1442 acquires outline log information SL1 and SL2 of application software AP1 and AP2 from storage unit 142 based on the acquired correspondence information. Acquired outline log information SL1 and SL2 include reference information indicating the respective storage locations of detailed log information DL1 and DL2 of application software AP1 and AP2 and services S1, S2, and S3. Acquisition unit 1442 acquires outline log information SL1 and SL2 for a specific time period such as the past several hours from storage unit 142, for example.

Transmission processing unit 1443 acquires detailed log information DL1 of application software AP1 corresponding to the identification information from storage unit 142 in vehicle 100. Further, transmission processing unit 1443 acquires detailed log information DL2 of at least one of the other application or the service that is associated with application software AP1 from storage unit 142 in vehicle 100 based on the correspondence information. Transmission processing unit 1443 then transmits detailed log information DL1 of application software AP1 and detailed log information DL2 of the other application or the like to the other device outside vehicle 100.

More specifically, transmission processing unit 1443 acquires detailed log information DL1 and DL2 of application software AP1 and AP2 and services S1, S2, and S3 from storage unit 142 by using the correspondence information. Transmission processing unit 1443 transmits detailed log information DL1 and DL2 of application software AP1 and AP2 and services S1, S2 and S3 to management device 12 via external communication unit 145.

For example, transmission processing unit 1443 acquires detailed log information DL1 and DL2 from storage unit 142 by using the reference information. More specifically, transmission processing unit 1443 acquires the reference information from storage unit 142, and acquires detailed log information DL1 and DL2 of application software AP1 and AP2 and services S1, S2 and S3 from the storage location indicated by the acquired reference information from storage unit 142.

Management device 12 analyzes detailed log information DL1 and DL2 of application software AP1 and AP2 and services S1, S2 and S3, and performs processing for causing application software AP1 to normally operate in accordance with the analyzed result. For example, management device 12 updates application software AP1. Specifically, management device 12 transmits application software AP1 for update to in-vehicle device 14.

Referring again to FIGS. 1 and 4, external communication unit 145 in in-vehicle device 14 outputs application software AP1 for update received from management device 12 to abnormality processing unit 146. Abnormality processing unit 146 transfers application software AP1 for update received from external communication unit 145 to in-vehicle device 15 via in-vehicle communication unit 141.

By installing application software AP1 transferred from in-vehicle device 14, in-vehicle device 15 upgrades the version of the application software to, for example, a safe version in terms of security.

### Operation Flow

Each device in the vehicle management system according to the first embodiment of the present disclosure includes a computer having a memory. An arithmetic processing unit such as a CPU in the computer reads a program including some or all of steps of the following sequence from the memory and executes the program. The programs of the plurality of devices can be each installed from the outside. The programs of the plurality of devices are each distributed as stored in a recording medium.

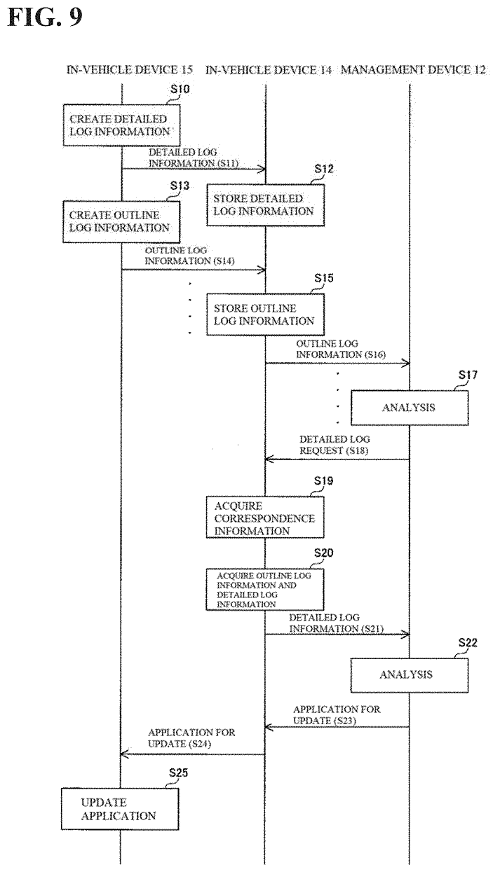

FIG. 9 is a sequence illustrating a vehicle management method in the vehicle management system according to the first embodiment of the present disclosure.

Referring to FIG. 9, in vehicle management system 1, at first, application software AP1 in in-vehicle device 15 creates detailed log information DL1 of application software AP1 (step S10).

Next, in-vehicle device 15 transmits created detailed log information DL1 to in-vehicle device 14 (step S11).

Next, in-vehicle device 14 stores detailed log information DL1 received from in-vehicle device 15 in storage unit 142 (step S12).

Next, application software AP1 in in-vehicle device 15 creates outline log information SL1 including reference information indicating the storage location of detailed log information DL1 of application software AP1 (step S13).

Next, in-vehicle device 15 transmits outline log information SL1 created by application software AP1 to in-vehicle device 14. Outline log information SL1 is created and transmitted periodically (step S14).

Next, in-vehicle device 14 stores outline log information SL1 received from in-vehicle device 15 in storage unit 142 (step S15).

Next, in-vehicle device 14 transmits outline log information SL1 received from in-vehicle device 15 to management device 12 (step S16).

Next, management device 12 analyzes whether or not outline log information SL1 received from in-vehicle device 14 includes an error log (step S17).

Next, when outline log information SL1 includes the error log, management device 12 transmits a detailed log request including the identification information of application software AP1 to in-vehicle device 14 (step S18).

Next, in-vehicle device 14 receives the detailed log request from management device 12, and acquires correspondence information indicating a correspondence relationship with at least one of other application software or a service used by application software AP1 from storage unit 142 based on the identification information (step S19).

Next, in-vehicle device 14 uses the acquired correspondence information to acquire detailed log information DL1 and DL2 and outline log information SL1 of application software AP1 and AP2 and services S1, S2 and S3 from storage unit 142 (step S20).

Next, in-vehicle device 14 transmits acquired detailed log information DL1 and DL2 of application software AP1, AP2 and services S1, S2 and S3 to management device 12 (step S21).

Next, management device 12 analyzes detailed log information DL1 and DL2 of application software AP1 and AP2 and services S1, S2 and S3 received from in-vehicle device 14 (step S22).

Next, management device 12 transmits application software AP1 for update to in-vehicle device 14 in order to normally operate application software AP1 based on the analyzed result (step S23).

Next, in-vehicle device 14 transmits application software AP1 for update received from management device 12 to in-vehicle device 15 (step S24).

Next, in-vehicle device 15 installs application software AP1 for update received from in-vehicle device 14 and updates application software AP1 (step S25).

In order to provide various services such as entertainment, various types of application software are installed in a vehicle. A plurality of pieces of application software installed in vehicle 100 often operates by mutually utilizing each other.

In the vehicle in which such various kinds of application software are installed, it is considered that services and application software are frequently added from the outside of the vehicle by OTA to improve a function, performance, and the like of the vehicle, which may lead a situation which has not occurred in a conventional vehicle.

Therefore, there is a demand for a technique for uploading logs of various kinds of application software from the vehicle to the SOC server as needed to quickly detect and cope with a situation that has occurred or is likely to occur in the vehicle in the future.

When each of the plurality of pieces of application software operating in the vehicle uploads a log to the SOC server, the SOC server needs to grasp other application software having a correspondence relationship with the application software to be managed for effective analysis.

The correspondence relationship of each application software may be changed when each application software is updated. In addition, each application software may have a different distributor, creator, and the like. For this reason, the administrator needs to refer to a design document of each application software or conduct an interview survey from the creator of each application software to grasp the correspondence relationship between each application software, and it is difficult to dynamically grasp the correspondence relationship between each application software.

In contrast, in the vehicle management program, in-vehicle device 14, and vehicle management system 1 according to the first embodiment of the present disclosure, as long as the administrator grasps the ID of the application software to be managed, the SOC server can acquire a necessary log from the vehicle without knowing the correspondence relationship between each application software, and the storage location of the log. Therefore, the SOC server can efficiently collect the log from the vehicle in which the application software is installed.

According to the program to collect vehicle log, in-vehicle device, vehicle log collection system, and vehicle log collection method according to the first embodiment, when the detailed log information of each application software is uploaded to management device 12, each application software does not have a communication function with management device 12, and application management unit 144 including transmission processing unit 1443 can mediate communication between each application software and management device 12. As a result, the administrator can ensure security by monitoring communication between application management unit 144 and management device 12, eliminating the need to monitor the communication between each application software and management device 12, and reducing a cost for monitoring.

Next, other embodiments according to the present disclosure will be described with reference to the drawings. Note that the same or corresponding parts in the drawings are denoted by the same reference numerals, and description thereof will not be repeated.

### Second Embodiment

In the first embodiment, application software AP1 to be managed detects an error of the application software by itself. On the other hand, in a second embodiment, a detection unit in in-vehicle device 14 detects an error of application software AP1 to be managed.

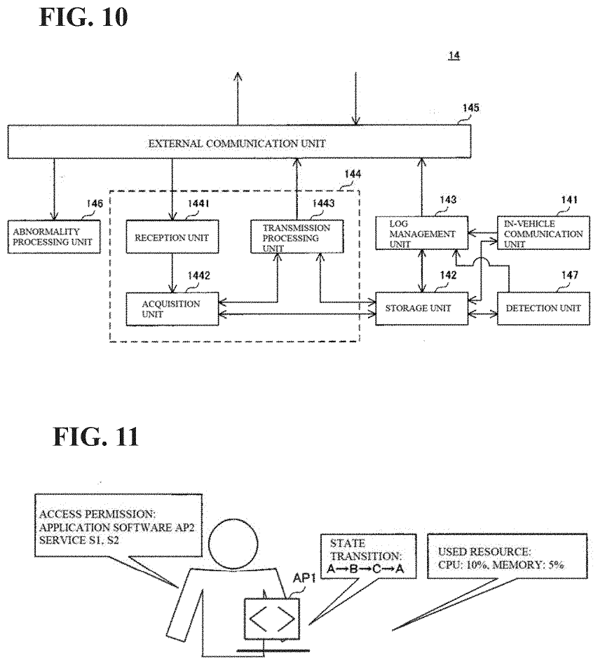

FIG. 10 is a diagram illustrating a configuration of the in-vehicle device according to the second embodiment of the present disclosure.

Referring to FIG. 10, in-vehicle device 14 further includes a detection unit 147 as compared with in-vehicle device 14 according to the first embodiment. Detection unit 147 is realized by a processor such as a central processing unit (CPU) or a digital signal processing (DSP).

Detection unit 147 detects an abnormality of application software AP1 in in-vehicle device 15. More specifically, detection unit 147 monitors a state transition of application software AP1, for example.

FIG. 11 is a diagram illustrating an example of correspondence information used for abnormality detection by detection unit 147 in the in-vehicle device according to the second embodiment of the present disclosure.

Referring to FIG. 11, a creator of application software AP1 to be managed in vehicle management system 1 defines an access permission, a state transition, a used resource, and the like of the application software and registers them in the correspondence information. That is, the correspondence information includes information indicating the definition content related to the behavior of application software AP1 installed in vehicle 100 in addition to information capable of identifying other application software and a service associated with application software AP1.

In an example shown in FIG. 11, application software AP2 and services S1 and S2 are permitted as the access destinations of application software AP1, the state transition is in the order of an A state, a B state, a C state and the A state. An occupancy rate of the CPU is 10% or less, and an occupancy rate of the memory is 5% or less as the used resource.

Detection unit 147 determines an abnormality of application software AP1 based on the correspondence information. More specifically, detection unit 147 can determine the abnormality of application software AP1 by referring to the correspondence information in storage unit 142.

Specifically, detection unit 147 can determine the abnormality of application software AP1 with respect to an access destination, a state transition, a resource usage state, and the like. Detection unit 147 is not limited to such an example, and may be configured to determine the abnormality of the version of application software AP1, for example.

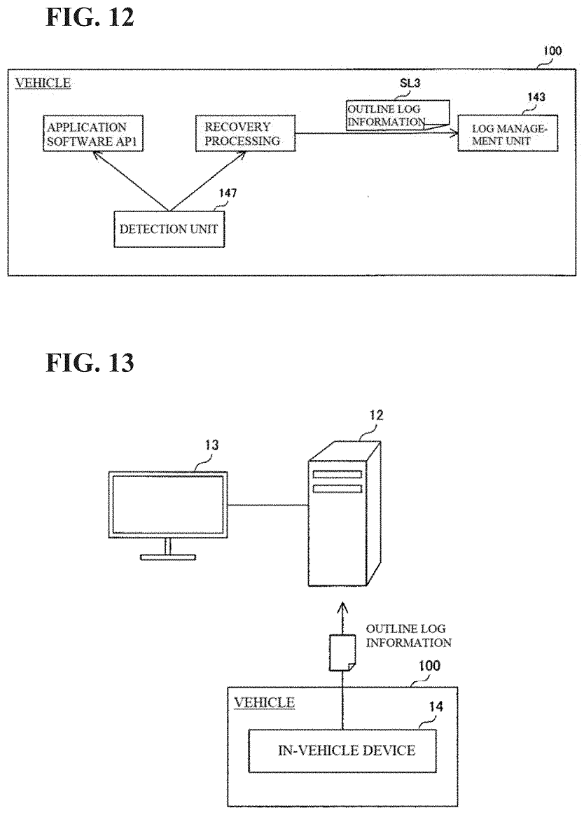

FIG. 12 is a diagram illustrating a notification method of a detection result by detection unit 147 according to the second embodiment of the present disclosure.

Referring to FIG. 12, the creator of application software AP1 describes, for example, in the program code of application software AP1, recovery processing for returning application software AP1 to a normal state in response to the abnormality occurred in application software AP1.

In response to the abnormality of application software AP1 being detected by detection unit 147, detection unit 147 calls a handler of the recovery processing included in the program code. The handler creates outline log information SL3 indicating the detection result. Detection unit 147 includes the application ID of application software AP1 in created outline log information SL3 to output to log management unit 143. Log management unit 143 transmits outline log information SL3 received from detection unit 147 to management device 12 via external communication unit 145.

Based on outline log information SL3 received from external communication unit 145, management device 12 transmits a detailed log request indicating that application software AP1 is designated to external communication unit 145 in in-vehicle device 14.

External communication unit 145 in in-vehicle device 14 outputs the detailed log request received from management device 12 to application management unit 144.

Since other configurations and operations are the same as those of the vehicle management system according to the first embodiment, detailed description thereof will not be repeated here.

### Third Embodiment

In the first embodiment, application software AP1 to be managed detects an error of the application software by itself. On the other hand, in the third embodiment, management device 12 detects an error of application software AP1 to be managed.

FIG. 13 is a diagram illustrating a configuration of a vehicle monitoring system according to the third embodiment of the present disclosure.

Referring to FIG. 13, management device 12 detects an abnormality of application software AP1 in in-vehicle device 15. More specifically, management device 12 monitors, for example, an update time of application software AP1.

Management device 12 receives outline log information SL1 on application software AP1 periodically transmitted from in-vehicle device 14. Outline log information SL1 includes the update time of application software AP1.

Management device 12 acquires campaign information indicating a scheduled update time of application software AP1. Management device 12 refers to the campaign information and checks whether the update time of application software AP1 indicated in outline log information SL1 matches the scheduled time. When the update time of application software AP1 does not match the scheduled time, management device 12 determines that an abnormality has occurred in application software AP1.

When management device 12 determines that the abnormality has occurred in application software AP1, management device 12 transmits, to external communication unit 145 in in-vehicle device 14, a detail log request indicating that application software AP1 is designated.

External communication unit 145 in in-vehicle device 14 outputs the detailed log request received from management device 12 to application management unit 144.

Since other configurations and operations are the same as those of the vehicle management system according to the first embodiment, detailed description thereof will not be repeated here.

### Fourth Embodiment

In the first to third embodiments, in-vehicle device 14 transmits the detailed log information of application software AP1 to management device 12 by using the outline log information in which the storage location of the detailed log information is described. On the other hand, in the fourth embodiment, in-vehicle device 14 transmits detailed log information of application software AP1 to management device 12 without using an outline log information.

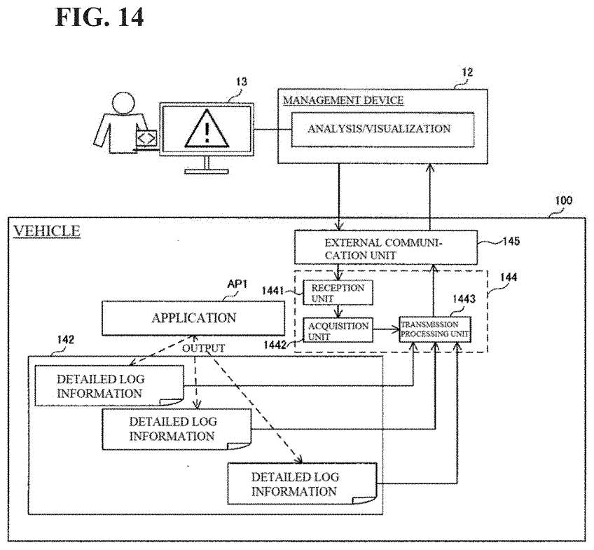

FIG. 14 is a diagram illustrating an example of a log collection method of application software to be managed in a vehicle monitoring system according to the fourth embodiment of the present disclosure.

Referring to FIG. 14, reception unit 1441 receives designation of identification information identifying application software AP1 for vehicle 100 and third reference information indicating a storage location of log information of application software AP1. More specifically, reception unit 1441 receives a detailed log request including the identification information and first reference information from management device 12 via external communication unit 145. The identification information is, for example, the ID of application software AP1. The third reference information is, for example, a relative path indicating the storage location of the detailed log information of application AP1. The relative path indicates the storage location of the log information of application software AP1 by a relative path with respect to the storage location of application software AP1. The relative path is input to management device 12 by an administrator or is stored in management device 12 in advance. Reception unit 1441 outputs the identification information and the third reference information included in the received detailed log request to acquisition unit 1442.

Acquisition unit 1442 acquires fourth reference information indicating the storage location of application software AP1 based on the identification information. More specifically, acquisition unit 1442 receives the identification information of application software AP1 from reception unit 1441, and acquires fourth reference information from a platform or middleware executing application software AP1. The fourth reference information is, for example, an absolute path indicating an installation destination (storage location) of application software AP1, and is registered in advance in the platform or the middleware. The fourth reference information may be directly registered in storage unit 142, and acquisition unit 1442 may directly acquire the fourth reference information from storage unit 142 without going through the platform or the middleware. Acquisition unit 1442 outputs the acquired fourth reference information and the third reference information received from reception unit 1441 to transmission processing unit 1443.

Transmission processing unit 1443 acquires the log information of application software AP1 based on the third reference information and the fourth reference information, and transmits the log information to the other device installed outside vehicle 100. More specifically, transmission processing unit 1443 receives the third reference information and the fourth reference information from acquisition unit 1442, and specifies the storage location of application software AP1 based on the fourth reference information which is the absolute path. Then, transmission processing unit 1443 specifies the storage location of the detailed log information of application software AP1 based on the third reference information which is the relative path from the storage location of application software AP1. The storage location of the detailed log information of application software AP1 is, for example, storage unit 142. Transmission processing unit 1443 acquires the detailed log information of application software AP1, and transmits it to management device 12 via external communication unit 145.

Management device 12 analyzes the detailed log information of application software AP1, and performs processing for causing application software AP1 to normally operate according to the analyzed result.

Since other configurations and operations are the same as those of the vehicle management system according to the first embodiment, detailed description thereof will not be repeated here.

When each of a plurality of pieces of application software operating in vehicle 100 directly uploads detailed log information to management device 12, it is necessary to monitor communication between each application software and management device 12 in order to ensure communication security. In this case, the communication is monitored as many times as the number of pieces of application software, which increases a load (cost) for monitoring increases.

In addition, there are a case in which the location where the detailed log information is output or stored is different for each application software and a case in which the deployment location of the application software is different for each in-vehicle device in which each application software is installed. Since management device 12 cannot uniquely grasp the location where the detailed log information of each application software is output or stored in vehicle 100, it is difficult for management device 12 to acquire and analyze the detailed log information of each application software.

In contrast, according to the program to collect vehicle log, in-vehicle device, vehicle log collection system, and vehicle log collection method of the fourth embodiment, when the detailed log information of each application software is uploaded to management device 12, each application software does not have a communication function with management device 12, and application management unit 144 including transmission processing unit 1443 can mediate communication between each application software and management device 12. This allows management device 12 to monitor communication between application management unit 144 and management device 12 in a centralized manner and to efficiently ensure security.

Further, according to the fourth embodiment, the third reference information which is the relative positional information developed by management device 12 and the fourth reference information which is the absolute positional information managed by application management unit 144 are combined to specify the storage location of the detailed log information of each application software. Therefore, even when management device 12 or the administrator does not grasp the storage location of the detailed log information of each application software, the identification information and the third reference information of the application software whose log is desired to be collected is transmitted to in-vehicle device 14 to acquire the detailed log information of the application software. Therefore, according to the fourth embodiment, it is possible to easily acquire and analyze the detailed log information of each application software in vehicle 100.

It should be understood that the above-described embodiments are merely illustrative and non-restrictive in all respects. The scope of the present disclosure is defined by the claims, but not by the above description, and is intended to include all modifications within the meaning and scope equivalent to the claims.

For example, in the first embodiment, the case where application software AP1 periodically creates outline log information SL1 is described. However, application software AP1 may create outline log information SL1 according to an event in the vehicle. More specifically, application software AP1 may create outline log information SL1, for example, in response to some error being detected.

For example, in the first to third embodiments, the case where in-vehicle device 14 is the central ECU is described. However, in-vehicle device 14 may be an in-vehicle device such as a TCU or an automatic driving ECU, and is not particularly limited.

For example, in the first to third embodiments, the case where in-vehicle device 14 manages application software AP1 installed in in-vehicle device 15 is described. However, in-vehicle device 14 may manage the application software installed in in-vehicle device 14, and the in-vehicle device in which the application software to be managed is installed is not particularly limited.

For example, in the first to third embodiments, the case is described in which detailed log information DL1 of application software AP1, outline log information SL1 of application software AP1, and detailed log information DL2 of application software AP2 to AP6 which are other application software are stored in the same storage unit, that is, storage unit 142 of in-vehicle device 14. However, detailed log information DL1 and DL2 and outline log information SL1 may be stored in the storage unit of any one of in-vehicle devices 15 to 20, or each of detailed log information DL1 and DL2 and outline log information SL1 may be stored in a storage unit in a separate in-vehicle device. For example, detailed log information DL1 may be stored in a first storage unit which is a storage unit of a certain in-vehicle device, outline log information SL1 may be stored in a second storage unit which is a storage unit of another in-vehicle device, and detailed log information DL2 may be stored in a third storage unit which is a storage unit of yet another in-vehicle device.

For example, in the first to third embodiments, the case where detailed log information DL1 and DL2 created in application software AP1 to AP6 are transmitted to in-vehicle device 14 as needed and accumulated in storage unit 142 of in-vehicle device 14. However, detailed log information DL1 and DL2 created in the application software AP1 to AP6 may be accumulated in the storage unit in in-vehicle devices 15 to 20 in which application software AP1 to AP6 are installed. In this case, for example, in-vehicle device 14 receives a detailed log request from management device 12 to acquire detailed log information DL1 and DL2 stored in each of in-vehicle devices 15 to 20 as necessary. This configuration allows reduction of the load on the in-vehicle network.

The above description includes features appended below.

### Supplementary Note 1

An in-vehicle device includes a reception unit configured to receive designation of identification information identifying first application software for use in a vehicle having a first storage unit and a second storage unit; an acquisition unit configured to acquire correspondence information indicating that first application software is associated with at least one of second application software that is for use in the vehicle and different from the first application software or a service for use in the vehicle; and a transmission processing unit configured to acquire first log information that is stored in the first storage unit of the vehicle and is on the first application software corresponding to the identification information from the first storage unit, acquire second log information that is stored in the second storage unit and is on at least one of the second application software or the service that is associated with the first application software from the second storage unit, and transmit the first log information and the second log information to a device installed outside the vehicle. The transmission processing unit transmits outline log information including reference information capable of identifying the first log information of the first application software to the device.

### REFERENCE SIGNS LIST

1 vehicle management system; 11, 12 management device; 13 display device; 14, 15, 16, 17, 18, 19, 20 in-vehicle device; 141 in-vehicle communication unit; 142 storage unit; 143 log management unit; 144 application management unit; 1441 reception unit; 1442 acquisition unit; 1443 transmission processing unit; 145 external communication unit; 146 abnormality processing unit; 147 detection unit; 100 vehicle

1. A non-transitory computer-readable recording medium storing a vehicle log collection program that causes a computer serving as an in-vehicle device to function as:
a reception unit configured to receive designation of identification information identifying first application software for use in a vehicle, the vehicle having a first storage unit and a second storage unit;
an acquisition unit configured to acquire correspondence information indicating that the first application software is associated with at least one of second application software or a service, the second application software being for use in the vehicle and different from the first application software, the service being for use in the vehicle; and
a transmission processing unit configured to
acquire first log information stored in the first storage unit from the first storage unit, the first log information being on the first application software corresponding to the identification information,
acquire second log information stored in the second storage unit from the second storage unit, the second log information being on at least one of the second application software or the service associated with the first application software, and
transmit the first log information and the second log information to a device installed outside the vehicle.

2. The recording medium according to claim 1, wherein
the vehicle has a third storage unit,
the acquisition unit is configured to acquire first outline log information and second outline log information from the third storage unit, the first outline log information including first reference information indicating a storage location of the first log information, the second outline log information including second reference information indicating a storage location of the second log information, and
the transmission processing unit is configured to acquire the first log information from the first storage unit by using the first reference information, and acquire the second log information from the second storage unit by using the second reference information.

3. The recording medium according to claim 2, wherein the first outline log information is information created, by the first application software, by omitting or converting at least part of the first log information, and the second outline log information is information created, by the second application software, by omitting or converting at least part of the second log information.

4. The recording medium according to claim 2, the vehicle log collection program further causing the computer to function as:
a detection unit configured to detect an abnormality of the first application software and an abnormality of the second application software, wherein
the first outline log information is created in response to the abnormality of the first application software being detected by the detection unit, and the second outline log information is created in response to the abnormality of the second application software being detected by the detection unit.

5. The recording medium according to claim 2, wherein the first outline log information includes an error log of the first application software, and the second outline log information includes an error log of the second application software.

6. The recording medium according to claim 1, wherein the correspondence information indicates that the first application software corresponding to the identification information is associated with the second application software and the service.

7. An in-vehicle device comprising:
a reception unit configured to receive designation of identification information identifying first application software for use in a vehicle, the vehicle having a first storage unit and a second storage unit;
an acquisition unit configured to acquire correspondence information indicating that the first application software is associated with at least one of second application software or a service, the second application software being for use in the vehicle and different from the first application software, the service being for use in the vehicle; and
a transmission processing unit configured to
acquire first log information stored in the first storage unit of the vehicle from the first storage unit, the first log information being on the first application software corresponding to the identification information,
acquire second log information stored in the second storage unit from the second storage unit, the second log information being on at least one of the second application software or the service associated with the first application software, and
transmit the first log information and the second log information to a device installed outside the vehicle.

8. A vehicle log collection system comprising:
an in-vehicle device to be mounted in a vehicle having a first storage unit and a second storage unit; and
a management device to be provided outside the vehicle and capable of communicating with the in-vehicle device, wherein
the in-vehicle device includes
a reception unit configured to receive designation of identification information identifying first application software for use in the vehicle,
an acquisition unit configured to acquire correspondence information indicating that the first application software is associated with at least one of the second application software or a service, the second application software being for use in the vehicle and different from the first application software, the service being for use in the vehicle, and
a transmission processing unit configured to
acquire first log information stored in the first storage unit of the vehicle from the first storage unit, the first log information being on the first application software corresponding to the identification information,
acquire second log information stored in the second storage unit from the second storage unit, the second log information being on at least one of the second application software or the service associated with the first application software, and
transmit the first log information and the second log information to the management device.

9. A vehicle log collection method for an in-vehicle device to be mounted in a vehicle having a first storage unit and a second storage unit, the vehicle log collection method comprising:
receiving designation of identification information identifying first application software for use in the vehicle;
acquiring correspondence information indicating that the first application software is associated with at least one of second application software or a service, the second application software being for use in the vehicle and different from the first application software, the service being for use in the vehicle; and
acquiring first log information stored in the first storage unit of the vehicle from the first storage unit, the first log information being on the first application software corresponding to the identification information, acquiring second log information stored in the second storage unit from the second storage unit, the second log information being on at least one of the second application software or the service associated with the first application software, and transmitting the first log information and the second log information to a device installed outside the vehicle.

10. A non-transitory computer-readable recording medium storing a vehicle log collection program that causes a computer serving as an in-vehicle device to function as:
a reception unit configured to receive designation of identification information identifying application software for use in a vehicle, and designation of third reference information indicating a storage location of log information on the application software by a relative positional relationship with respect to a storage location of the application software;
an acquisition unit configured to acquire fourth reference information indicating the storage location of the application software corresponding to the identification information; and
a transmission processing unit configured to
specify, based on the third reference information and the fourth reference information, the storage location of the log information on the application software,
acquire the log information from the specified storage location, and
transmit the acquired log information to a device installed outside the vehicle.

11. A vehicle log collection method for an in-vehicle device to be mounted in a vehicle, the vehicle log collection method comprising:
receiving designation of identification information identifying application for use in the vehicle, and designation of third reference information indicating a storage location of log information on the application software by a relative positional relationship with respect to a storage location of the application software;
acquiring fourth reference information indicating the storage location of the application software corresponding to the identification information;
specifying, based on the third reference information and the fourth reference information, the storage location of the log information on the application software;
acquiring the log information from the specified storage location; and
transmitting the acquired log information to a device installed outside the vehicle.
